(19) United States
(12) Patent Application Publication
(10) Pub. No.: US 2015/0069931 A1
(43) Pub. Date: Mar. 12, 2015

(54) SCANNING LIGHT-EMITTING DEVICE WITH INCREASED LIGHT INTENSITY

(71) Applicant: Nisho Image Tech Inc., New Taipei City (TW)

(72) Inventor: Harunobu Yoshida, Ushiku City (JP)

(21) Appl. No.: 14/462,623

(22) Filed: Aug. 19, 2014

(30) Foreign Application Priority Data
Sep. 6, 2013 (TW) 102216852

(51) Int. Cl. H05B 37/02; G03G 15/043

(52) U.S. Cl. CPC H05B 37/0209; G03G 15/043
USPC 315/294

(57) ABSTRACT

A scanning light-emitting device with increased light intensity includes a light-emitting circuit and a shift circuit including a plurality of shift thyristors, a plurality of diodes and a plurality of shift signal lines. The plurality of shift thyristors is divided into a plurality of groups at intervals. Each of the shift signal lines is electrically connected to the shift thyristors belonging to one of the groups. The light-emitting circuit includes a plurality of light-emitting thyristors and a plurality of light-emitting control lines. Each of the light-emitting thyristors is correspondingly electrically connected to one of the shift thyristors. Each of the light-emitting control lines is electrically connected to the light-emitting thyristors electrically connected to the shift thyristors belonging to one of the groups. The total light-emitting intensity can be increased through partial overlap during light-emitting of the light-emitting thyristors in adjacent groups.

### CROSS-REFERENCES TO RELATED APPLICATIONS

This non-provisional application claims priority under 35 U.S.C. §119(a) on Patent Application No. 102216852 filed in Taiwan, R.O.C. on 2013 Sep. 6, the entire contents of which are hereby incorporated by reference.

### BACKGROUND

1. Technical Field

The present utility model relates to a scanning light-emitting device, and more particularly, to a scanning light-emitting device with increased light intensity.

2. Related Art

Copiers, printers, fax machines and multi-function printers (MFPs) use Electro-photography as the core technology of printing files, that is, change distribution of electrostatic charges by light having a particular wavelength to generate photographic images.

Referring to FIG. 1, a schematic structural view of a color printing light-emitting diode (LED) printer 100 is shown. The LED printer 100 has a photoconductive drum (110K, 110M, 110C, 110Y, generally referred to as 110), a printing head (120K, 120M, 120C, 120Y, generally referred to as 120) and a toner cartridge (130K, 130M, 130C, 130Y, generally referred to as 130) that are respectively corresponding to black, magenta, cyan and yellow. By using a power distribution mechanism, a surface of the photoconductive drum 110 may generate a layer of uniform charges. The scanning process prior to printing requires an exposure process, so that pattern pixels in files to be printed are converted into visible light and dark information. The printing head 120 has a plurality of one-dimensionally arranged light-emitting diodes, when light emitted by the LEDs is irradiated onto the photoconductive drum 110, unexposed areas may maintain the original potential, but charges of the exposed areas may differ due to exposure. A potential change difference of the exposed area may adsorb toner with positive/negative charges provided by the toner cartridge 130, thereby achieving the aim of printing.

FIG. 2 is a schematic view of sensing of the printer 100. As shown in FIG. 2, the printing device includes a photoconductive drum 110, a printing head 120 and a lens 150. The lens 150 is located between the photoconductive drum 110 and the printing head 120, and is used to focus light emitted from the printing head 120 on the photoconductive drum 110, so as to implement the foregoing exposure process.

FIG. 3 is a schematic top view of the printing head 120. As shown in FIG. 3, the printing head 120 includes a plurality of light-emitting chips 122 arranged along an axis 140. Generally, each light-emitting chip 122 includes thousands of light-emitting units (e.g., LEDs) linearly arranged. When the light-emitting chips 122 are arranged along the axis 140, the light-emitting units are also arranged along the axis 140, so as to achieve high DPI printing resolution. For example, to achieve 600 DPI resolution, it is necessary to arrange 600 light-emitting units in each inch.

It can be understood from the above description that, when the printing speed is to be increased, the light-emitting time of each light-emitting unit will be shortened; therefore, how to increase the printing speed while keeping good printing quality is a problem that researchers in this field hope to solve.

### SUMMARY

In view of the above problem, the present utility model provides a scanning light-emitting device with increased light intensity, thereby solving the problem of how to increase the printing speed while keeping good printing quality existing in the prior art.

An embodiment of the present utility model provides a scanning light-emitting device with increased light intensity, including a shift circuit and a light-emitting circuit.

The shift circuit includes a plurality of shift thyristors, a plurality of diodes and a plurality of shift signal lines. The plurality of shift thyristors is divided into a plurality of groups at intervals. Each of the diodes is electrically connected between two adjacent shift thyristors. Each of the shift signal lines is electrically connected to the shift thyristors belonging to one of the groups, where the number of the shift signal lines is the same as that of the groups.

The light-emitting circuit includes a plurality of light-emitting thyristors and a plurality of light-emitting control lines. Each of the light-emitting thyristors is correspondingly electrically connected to one of the shift thyristors. Each of the light-emitting control lines is electrically connected to the light-emitting thyristors electrically connected to the shift thyristors belonging to one of the groups, where the number of the light-emitting control lines is the same as that of the groups.

According to the scanning light-emitting device with increased light intensity of the present utility model, a light-emitting term of each light-emitting thyristor can be extended, and thus the total light-emitting intensity of each light-emitting thyristor can be extended in a limited printing term. Accordingly, the printing speed can be improved and the original light-emitting intensity and printing quality can be maintained.

### BRIEF DESCRIPTION OF THE DRAWINGS

FIG. 1 is a prior art of a schematic structural view of a color printing LED printer;

FIG. 2 is a prior art of a schematic view of sensing of the printer;

FIG. 3 is a prior art of a schematic top view of a printing head;

FIG. 4 is a circuit diagram of a scanning light-emitting device according to an embodiment of the present utility model;

FIG. 5 is a schematic signal view of a scanning light-emitting device according to an embodiment of the present utility model;

FIG. 6 is a schematic top view of an integrated circuit of a scanning light-emitting device according to an embodiment of the present utility model; and

FIG. 7 is a schematic side view of an integrated circuit of a scanning light-emitting device according to an embodiment of the present utility model.

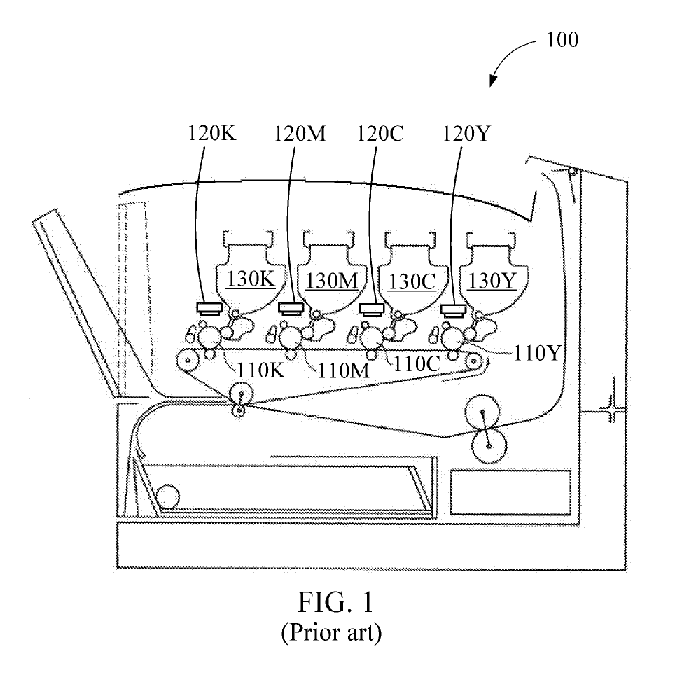

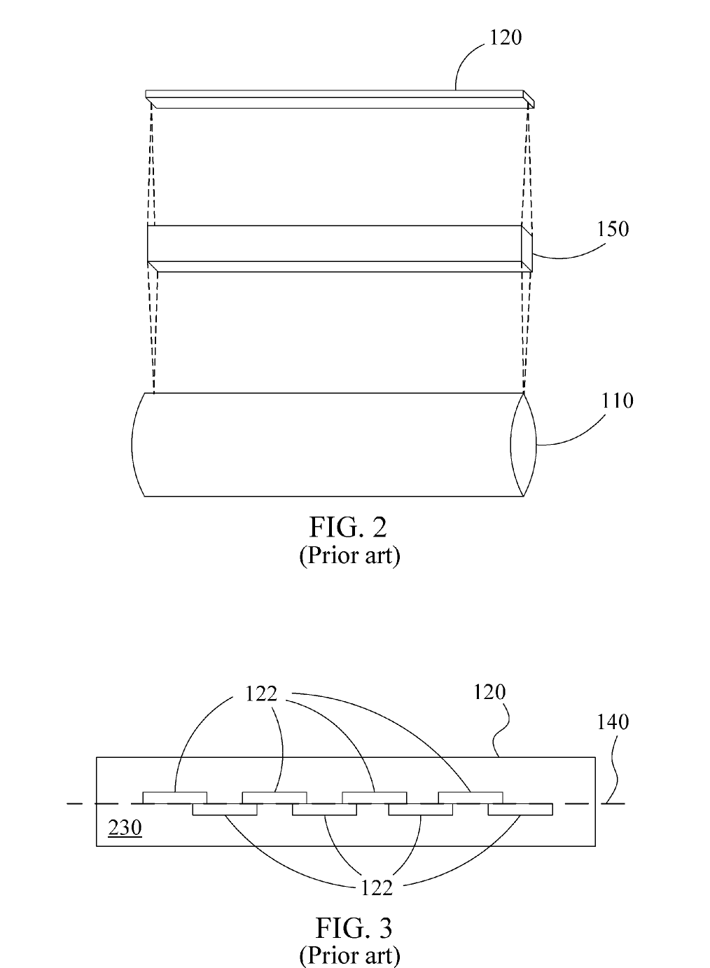

### DETAILED DESCRIPTION

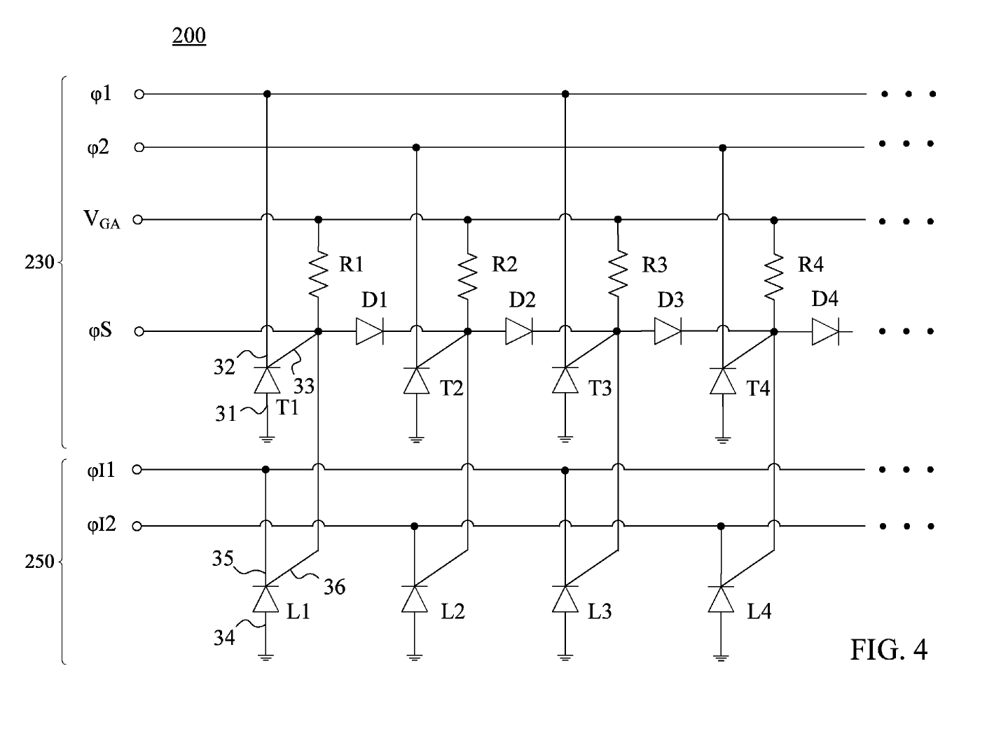

FIG. 4 is a circuit diagram of a scanning light-emitting device 200 according to an embodiment of the present utility model. The scanning light-emitting device 200 with increased light intensity (hereinafter referred to as a scanning light-emitting device for short) of the present utility model may be the foregoing light-emitting chip 122.

As shown in FIG. 4, the scanning light-emitting device 200 includes a shift circuit 230 and a light-emitting circuit 250. The shift circuit 230 includes a plurality of shift thyristors (T1, T2, T3 and T4, generally called T), a plurality of diodes (D1, D2, D3 and D4, generally called D) and a plurality of shift signal lines (herein taking two shift signal lines φ1 and φ2 as an example). The light-emitting circuit 250 includes a plurality of light-emitting thyristors (L1, L2, L3 and L4, generally called L) and a plurality of light-emitting control lines (herein taking two light-emitting control lines φI1 and φI2 as an example).

The shift thyristors T are divided into a plurality of groups at intervals. Therefore, in this embodiment, odd shift thyristors (T1, T3 and the like) are considered as a group (hereinafter referred to as “odd group”), and even shift thyristors (T2, T4 and the like) are considered as a group (hereinafter referred to as “even group”). Each diode D is electrically connected between two adjacent shift thyristors T. Each of the shift signal lines is electrically connected to the shift thyristors T belonging to one of the groups. For example, the shift signal line φ1 is electrically connected to each of the shift thyristors (T1, T3 and the like) of the odd group; and the shift signal line φ2 is electrically connected to each of the shift thyristors (T2, T4 and the like) of the even group. Therefore, the number of the shift signal lines is the same as that of the groups.

Each of the light-emitting thyristors T is correspondingly electrically connected to one of the shift thyristors T. That is, a light-emitting thyristor Ln is electrically connected to a shift thyristor Tn, where n is a positive integer. For example, a light-emitting thyristor L1 is electrically connected to a shift thyristor T1, and a light-emitting thyristor L2 is electrically connected to a shift thyristor T2. Each of the light-emitting control lines is electrically connected to the light-emitting thyristors L electrically connected to the shift thyristors T belonging to one of the groups. For example, a light-emitting control line φI1 is electrically connected to a light-emitting thyristor L connected to a shift thyristor T in the odd group (hereinafter referred to as the light-emitting thyristor of the odd group); a light-emitting control line φI2 is electrically connected to a light-emitting thyristor L connected to a shift thyristor T in the even group (hereinafter referred to as the light-emitting thyristor of the even group). Herein, the number of the light-emitting control lines is also the same as that of the groups.

Each shift thyristor T includes a first anode end 31, a first cathode end 32 and a first gate end 33; each light-emitting thyristor L includes a second anode end 34, a second cathode end 35 and a second gate end 36. The shift thyristors T and the light-emitting thyristors L electrically connected with each other are electrically connected through respectively the first gate end 33 and the second gate end 36. Two ends of each of the diodes D are respectively electrically connected to the first gate end 33 of two adjacent shift thyristors T. For example, an anode end of a diode D1 is electrically connected to the first gate end 33 of the shift thyristor T1, and a cathode end thereof is electrically connected to the first gate end 33 of another shift thyristor T2. Each shift thyristor T is electrically connected to the corresponding shift signal line with the first cathode end 32 thereof, and the first anode end 31 of each shift thyristor T is grounded. Similarly, the second cathode end 35 of each light-emitting thyristor L is electrically connected to the corresponding light-emitting control line, and the second anode end 34 of each light-emitting thyristor L is grounded.

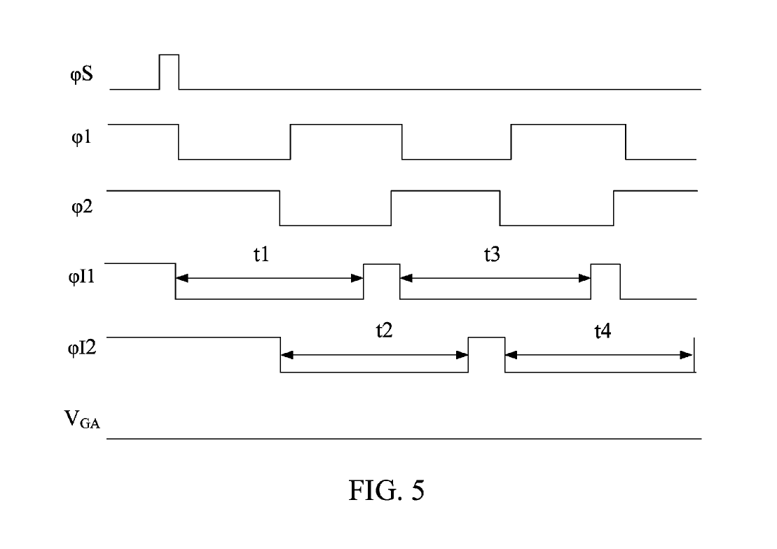

The shift circuit 230 further includes a pulldown signal line V_{GA}, an initial signal line φS and a plurality of load resistors (R1, R2, R3 and R4, generally called R). The first gate end 33 of each shift thyristor T is electrically connected to a load resistor R (for example, the first gate end 33 of the shift thyristor T1 is electrically connected to the load resistor R1). One end of the load resistor R is electrically connected to the first gate end 33, and the other end is electrically connected to the pulldown signal line V_{GA}. The pulldown signal line V_{GA} provides a pulldown voltage level (herein it is a negative potential) for the load resistors R, so that the first gate end 33 and the first anode end 31 of the actuating shift thyristor T can have a forward bias therebetween. The initial signal line φS is electrically connected to the first gate end 33 of the first shift thyristor T1, so as to feed a single pulse (as shown in FIG. 5) actuated by triggering sequential shifting of the shift circuit 230.

FIG. 5 is a schematic signal view of a scanning light-emitting device 200 according to an embodiment of the present utility model, which schematically shows a timing relation of signals fed by the signal line or control line.

As shown in FIG. 5, after the initial signal line φS feeds the single pulse, two shift signal lines φ1 and φ2 respectively feed pulse signals with substantially the same pulse width but a phase difference being between 90 degrees to 180 degrees. Therefore, in coordination with the shift circuit 230 as shown in FIG. 4, the first anode end 32 of the shift thyristor T can be sequentially changed into a low voltage level along a forward conduction direction of the diode D. Because the second gate end 36 of the light-emitting thyristor L is connected to the first gate end 33 of the shift thyristor T, the second gate end 36 of the light-emitting thyristor L may also be sequentially actuated following the shift thyristor T. When the first anode end 32 of the next shift thyristor T (or the second anode end 35 of the light-emitting thyristor L) has been changed into a low voltage level for a period of time, the first anode end 32 of the previous shift thyristor T (or the second anode end 35 of the light-emitting thyristor L) is restored to a high voltage level. Herein, the high voltage level is a ground level (i.e., 0 V), and the low voltage level is a negative level (e.g., −5 V).

The characteristic of a thyristor such as the shift thyristor T and the light-emitting thyristor L is as follows: when a forward bias is applied between an anode and a cathode and a breakdown voltage exceeding a PN junction is applied between a gate and the cathode, the thyristor may be conducted, and after a bias between the gate and the cathode is removed, the thyristor may still maintain a conducted state, and it is restored to a non-conducted state until the forward bias between the anode and the cathode disappears. Therefore, when the first gate end 33 of the shift thyristor T1 receives a first low level pulse of the shift signal line φ1 and starts, the corresponding light-emitting thyristor L1 also starts and emits light because it also receives a first low level pulse fed by the light-emitting control line φI1, and after the first low level pulse of the shift signal line φ1 ends, it can continuously emit light, until the first low level pulse fed by the light-emitting control line φI1 ends, so that it can continuously emit light in a light-emitting term t1. Similarly, the light-emitting thyristors L2, L3 and L4 respectively emit light in light-emitting terms t2, t3 and t4.

As shown in FIG. 5, each of the light-emitting control lines φI1 and φI2 feeds a light-emitting signal having a plurality of low voltage level intervals, and the low voltage level intervals of the light-emitting signals fed by the two light-emitting control lines φI1 and φI2 corresponding to the adjacent groups are partially overlapped. An intermittent interval (i.e., a high voltage level interval) between two adjacent low voltage level intervals of each light-emitting signal corresponds to the low voltage level interval of the adjacent light-emitting signal. That is to say, two light-emitting control lines φI1 and φI2 may respectively control light-emitting terms of the light-emitting thyristors L of the odd group and the even group, and thus the light-emitting terms of the light-emitting thyristors L of the odd group and the even group can be partially overlapped. Therefore, the light-emitting term of each light-emitting thyristor L can be extended, and the total light-emitting intensity of each light-emitting thyristor L can be extended in a limited printing term. Accordingly, the printing speed can be improved and the original light-emitting intensity and printing quality can be maintained.

Herein, although the high voltage level in the text is a ground level (i.e., 0 V), and the low voltage level is a negative level (e.g., −5 V), persons skilled in the art can reverse polarities of the elements and can change the high voltage level into a positive voltage level (e.g., 5 V), and change the low voltage level into a ground level.

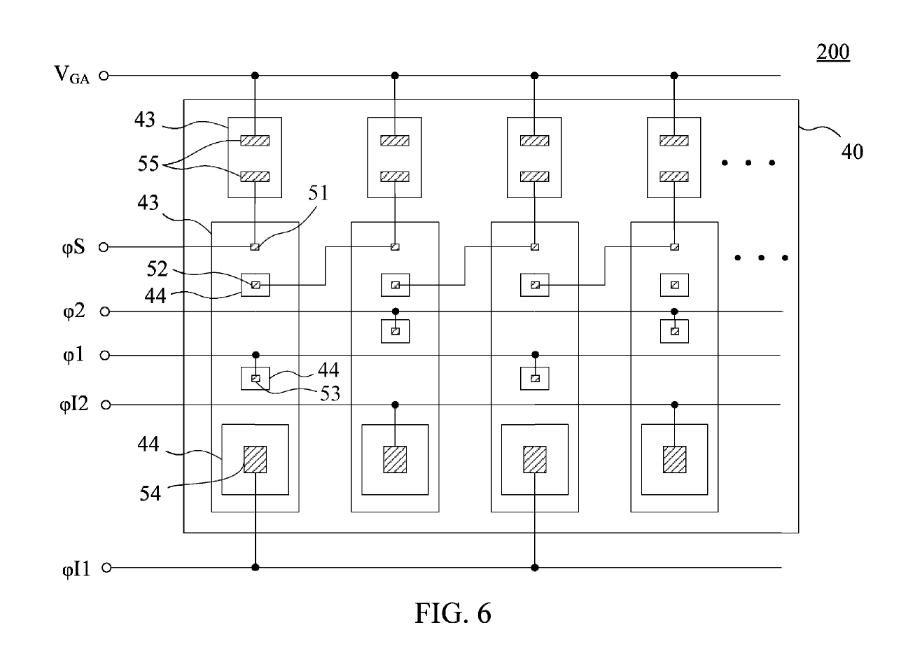

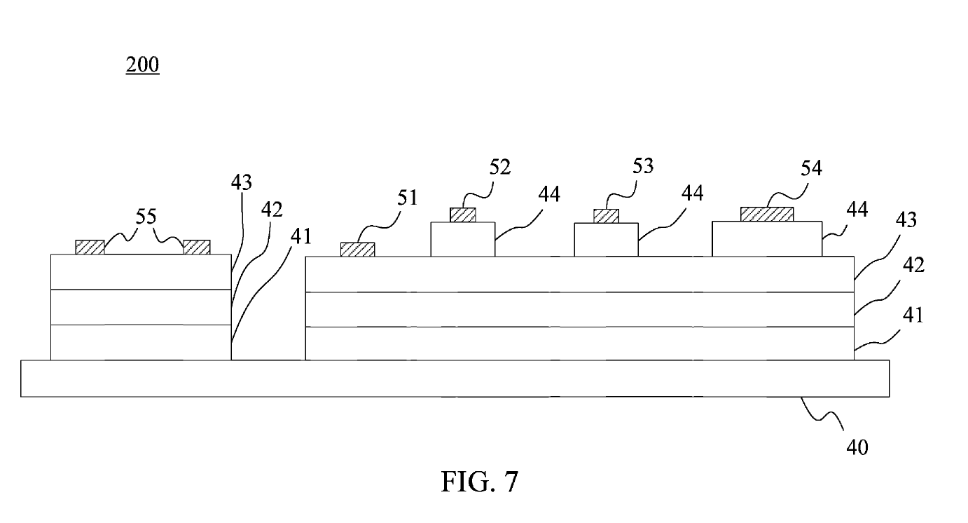

FIG. 6 is a schematic top view of an integrated circuit of a scanning light-emitting device 200 according to an embodiment of the present utility model. FIG. 7 is a schematic side view of an integrated circuit of a scanning light-emitting device 200 according to an embodiment of the present utility model.

Referring to FIG. 6 and FIG. 7 together, the shift thyristors T and the light-emitting thyristors L may be a PNPN construction formed by sequentially laminating a first conductive type epitaxial layer 41, a second conductive type epitaxial layer 42, a first conductive type epitaxial layer 43, and a second conductive type epitaxial layer 44 on a first conductive type substrate 40.

Herein, the first conductive type substrate may be of a GaAs material, and the first conductive type epitaxial layer and the second conductive type epitaxial layer may be of an AlGaAs material.

Referring to FIG. 4, FIG. 6 and FIG. 7 together, the first gate end 33 of the shift thyristor T, the second gate end 36 of the light-emitting thyristor L and the anode end of the diode D are connected with each other, and thus the shift thyristor T, the light-emitting thyristor L and the diode D share the same ohmic electrode 51. The ohmic electrode 51 is formed on the first conductive type epitaxial layer 43. The diode D is composed of the first conductive type epitaxial layer 43 and the second conductive type epitaxial layer 44 sequentially laminated on the second conductive type epitaxial layer 42. Moreover, the cathode end of the diode D has an ohmic electrode 52, which is formed on the second conductive type epitaxial layer 44. The first cathode end 32 of the shift thyristor T has an ohmic electrode 53, which is formed on the second conductive type epitaxial layer 44. The second cathode end of the light-emitting thyristor L has an ohmic electrode 54, which is formed on the second conductive type epitaxial layer 44. Herein, the second conductive type epitaxial layers 44 of the diode D, the shift thyristor T and the light-emitting thyristor L are not connected with each other.

The resistor R may be formed by another first conductive type epitaxial layer 41, another second conductive type epitaxial layer 42, and another first conductive type epitaxial layer 43 sequentially laminated on the first conductive type substrate 40. Moreover, two ohmic electrodes 55 are formed on the first conductive type epitaxial layer 43, which can serve as two ends of the resistor R, so as to be connected to other elements or signal lines.

In an embodiment, a Schottky barrier diode D can be formed through direct Schottky contact with the first conductive type epitaxial layer 43 through wiring.

In the above construction, the first conductive type is a P type, and the second conductive type is an N type, but embodiments of the present utility model are not limited thereto. In some embodiments, the first conductive type may be the N type, the second conductive type may be the P type, and the polarities of the cathode and the anode are opposite.

According to the scanning light-emitting device with increased light intensity of the present utility model, a light-emitting term of each light-emitting thyristor L can be extended, and thus the total light-emitting intensity of each light-emitting thyristor L can be extended in a limited printing term. Accordingly, the printing speed can be improved and the original light-emitting intensity and printing quality can be maintained.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A scanning light-emitting device with increased light intensity, comprising:
a shift circuit, comprising:
a plurality of shift thyristors, divided into a plurality of groups at intervals;
a plurality of diodes, each electrically connected between two adjacent shift thyristors; and
a plurality of shift signal lines, each electrically connected to the shift thyristors belonging to one of the groups, wherein the number of the shift signal lines is the same as that of the groups; and
a light-emitting circuit, comprising:
a plurality of light-emitting thyristors, each correspondingly electrically connected to one of the shift thyristors; and
a plurality of light-emitting control lines, each electrically connected to the light-emitting thyristors electrically connected to the shift thyristors belonging to one of the groups, wherein the number of the light-emitting control lines is the same as that of the groups.

2. The scanning light-emitting device according to claim 1, wherein the number of the groups is two.

3. The scanning light-emitting device according to claim 1, wherein each of the shift thyristors comprises a first anode end, a first cathode end and a first gate end, each of the light-emitting thyristors comprises a second anode end, a second cathode end and a second gate end, wherein the shift thyristor and the light-emitting thyristor electrically connected with each other are electrically connected respectively through the first gate end and the second gate end.

4. The scanning light-emitting device according to claim 3, wherein two ends of each of the diodes are respectively electrically connected to the first gate ends of two adjacent shift thyristors.

5. The scanning light-emitting device according to claim 3, wherein the first cathode end of each of the shift thyristors is electrically connected to the corresponding shift signal line, and the first anode end of each of the shift thyristors is grounded.

6. The scanning light-emitting device according to claim 3, wherein the first gate end of each of the shift thyristors is electrically connected to a load resistor.

7. The scanning light-emitting device according to claim 6, wherein the shift circuit further comprises a pulldown signal line, electrically connected to the load resistors, so as to provide a pulldown potential for the load resistors.

8. The scanning light-emitting device according to claim 3, wherein the second cathode end of each of the light-emitting thyristors is electrically connected to the corresponding light-emitting control line, and the second anode end of each of the light-emitting thyristors is grounded.

9. The scanning light-emitting device according to claim 3, wherein each of the light-emitting control lines feeds a light-emitting signal having a plurality of low voltage level intervals, and the low voltage level intervals of the light-emitting signals fed by the two light-emitting control lines corresponding to the adjacent groups are partially overlapped.

10. The scanning light-emitting device according to claim 9, wherein an intermittent interval between two adjacent low voltage level intervals of each light-emitting signal corresponds to the low voltage level interval of the adjacent light-emitting signal.
